(19) United States
(12) Patent Application Publication
(10) Pub. No.: US 2015/0187338 A1
(43) Pub. Date: Jul. 2, 2015

(54) DISPLAY DEVICE AND DISPLAY METHOD THEREOF

(71) Applicant: Samsung Display Co., Ltd., Yongin-city (KR)

(72) Inventor: Hoeung LEE, Suwon-si (KR)

(21) Appl. No.: 14/338,053

(22) Filed: Jul. 22, 2014

(30) Foreign Application Priority Data
Dec. 27, 2013 (KR) 10-2013-0165564

(51) Int. Cl. G09G 5/377; G06F 1/16; G06F 3/0484; G06F 3/0486; G09G 5/36; G06F 3/0488

(52) U.S. Cl. CPC G09G 5/377; G09G 5/363; G06F 3/04883; G06F 3/04845; G06F 3/0486; G06F 3/04842; G06F 1/1641; G09G 2354/00; G09G 2340/12; G09G 2340/14; G09G 2340/045; G09G 2320/10; G09G 2320/08; G09G 2380/00

(57) ABSTRACT

A display device including a display unit configured to output a base image; a curvature sensing unit configured to sense one of a forward folded state and a reverse folded state of the display unit; and an interface control unit configured to generate an interface image. The interface image may include a forward folded interface image corresponding to the forward folded state of the display unit, or a reverse folded interface image corresponding to the reverse folded state of the display unit. The interface control unit is configured to overlay the interface image on a base image and output the overlaid image.

### CROSS-REFERENCE TO RELATED APPLICATIONS

This application claims priority from and the benefit of Korean Patent Application No. 10-2013-0165564, filed on Dec. 27, 2013, which is hereby incorporated by reference for all purposes as if fully set forth herein.

### BACKGROUND

1. Field

Exemplary embodiments of the present invention relate to a display device and a display method thereof. More particularly, exemplary embodiments of the present invention relate to a foldable display device, and a display method thereof.

2. Description of the Background

Recently, display devices have been extensively used based on their degree of mobility. These display devices each include a display unit to support various functions, and the size of the display in the display unit may be limited to a certain size as a result of spatial conditions according to the portability and arrangement of other devices during display device manufacturing.

However, with the development of a display unit satisfying such spatial conditions and portability, a display device having a foldable display unit has recently been developed. Accordingly, a user interface appropriate for the folding and unfolding the display unit of a foldable display device is needed.

The above information disclosed in this Background section is only for enhancement of understanding of the background of the invention and, therefore, it may contain information that does not constitute the prior art.

### SUMMARY

Exemplary embodiments of the present invention provide an optimized user interface for a folding and unfolding display device.

Exemplary embodiments of the present invention also provide a display method of the display device.

Additional aspects will be set forth in part in the description which follows and, in part will be apparent from the description, or may be learned by practice of the invention.

An exemplary embodiment of the present invention discloses a display device including: a foldable display unit configured to output a base image; a curvature sensing unit configured to sense forward folded and reverse folded states of the foldable display unit; and an interface control unit configured to generate an interface image comprising one of a forward folded interface image corresponding to the forward folded state of the display unit, and unfolding reverse folded interface image corresponding to the reverse folded state of the display unit. The interface control unit is also configured to overlay the interface image on the base image, and to output the overlaid image.

An exemplary embodiment of the present invention also discloses a display method including: outputting a base image on a display unit comprising a first display unit and a second display unit that are pivotably connected at a position enabling forward folding and reverse folding movements to occur; sensing forward folded and reverse folded states of the display unit; generating an interface image as the forward folded and reverse folded states of the display unit are sensed; overlaying the interface image on the base image; and outputting the overlaid image.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention, and are incorporated in and constitute a part of this specification, illustrate exemplary embodiments of the invention and, together with the description, serve to explain principles of the present invention.

FIG. 1 is a block diagram of a configuration of a display device according to an exemplary embodiment of the present invention.

FIGS. 2, 3, 4, 5, and 6 are views illustrating a display unit when a display device is forward folded according to an exemplary embodiment of the present invention.

FIGS. 7, 8, 9, 10, and 11 are views illustrating a display unit when a display device is reverse folded according to an exemplary embodiment of the present invention.

FIG. 12 is a flowchart illustrating a display method according to an exemplary embodiment of the present invention.

### DETAILED DESCRIPTION OF THE ILLUSTRATED EMBODIMENTS

The present invention will be described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of elements may be exaggerated for clarity. Like reference numerals in the drawings denote like elements.

Throughout this specification and the claims that follow, it will be understood that when an element is referred to as being “coupled” to another element, the element may be “directly coupled” to the other element or “electrically coupled” to the other element through a third element. In contrast, when an element is referred to as being “directly coupled to” another element, there are no intervening elements present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

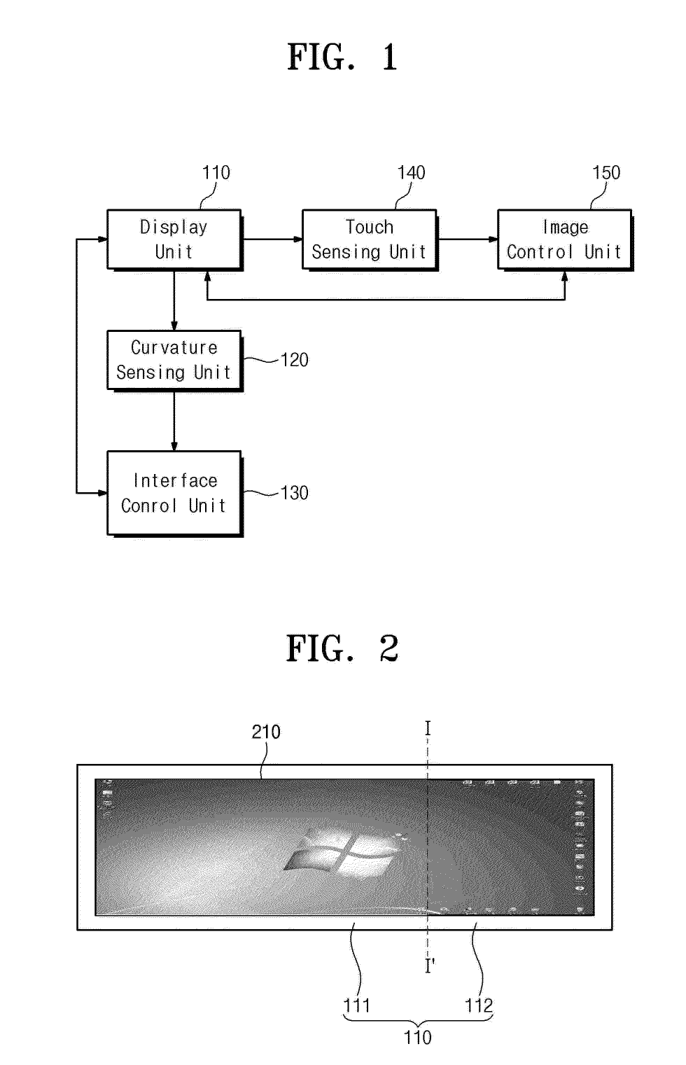

FIG. 1 is a block diagram of a configuration of a display device according to an exemplary embodiment of the present invention.

Referring to FIG. 1, the display device includes a display unit 110, a curvature sensing unit 120, an interface control unit 130, a touch sensing unit 140, and an image control unit 150.

The display device may be a tablet PC, a notebook PC, a slate PC, a mobile phone, an MP3 player, a TV, or a monitor.

The display unit 110 may be capable of being forward folded or reverse folded, and outputs a base image 210, as shown in FIG. 2. The display unit 110 may include an organic light emitting display panel, a liquid crystal display panel, a plasma display panel, an electrophoretic display panel, or an electrowetting display panel.

The display unit 110 includes a first display unit 111 and a second display unit 112, which are pivotably divided at the position (for example, line I-I′ of FIG. 2) at which the forward folding and reverse folding movements occur. Although the display unit 100 includes the first display unit 111 and the second display unit 112, if there are additional positions at which the forward folding and reverse folding movements may occur, additional display units, for example, a third display unit, a fourth display unit, and so on, may be included.

The “forward folding state” is defined as a range of folding angles in which the display unit 110 is folded inward so that the base image 210 outputted to the display unit 110 is viewable. For example, if an unfolded angle between the first display unit 111 and the second display unit 112 is 180°, an angle between the first display unit 111 and the second display unit 112 may be more than 30° and less than 180° in the forward folded state.

Also, the “reverse folded state” is defined as a range of folding angles in which the display unit 110 is folded outward so that the base image 210 outputted to the display unit 110 is viewable. For example, if an unfolded angle between the first display unit 111 and the second display unit 112 is 180°, an angle between the first display unit 111 and the second display unit 112 may be more than 180° and less than 270° in the reverse folded state.

The curvature sensing unit 120 detects the forward folded and reverse folded states of the display unit 110. For example, the forward folding and reverse folding movements of the display unit 110 may be performed by a hinge, and the curvature sensing unit 120 may sense operation of the hinge.

The interface control unit 130 generates an interface image including a forward folded interface image corresponding to the forward folded state of the display unit 110, and a reverse folded interface image corresponding to the reverse folded state of the display unit 110, and outputs the interface image to overlay it on the base image 210. The interface control unit 130 controls overall operations of the display device and, if the display unit 110 is forward folded and reverse folded, different interface images may be outputted according to usage purpose and environment.

A touch sensing unit 140 sensing an input of a user selecting the interface image may be further included. The touch sensing unit 140 may be integrally formed with the display unit 110.

The display device generates image data corresponding to the user input, and may further include an image control unit 150 outputting the image data to the display unit 110. The image control unit 150 controls overall operations of the display device, and when the display unit 110 is forward folded and reverse folded, different image data may be outputted according to usage purpose and environment.

FIGS. 2 to 6 are views illustrating the display unit 110 when a display device is folded according to an exemplary embodiment of the present invention.

Referring to FIG. 2, the display unit 110 outputs the base image 210. The display unit 110 may include a first display unit 111 and a second display unit 112, which are divided based on the position (for example, line I-I′ of FIG. 2) at which the forward folding and reverse folding movements occur. The sizes of the first display unit 111 and the second display unit 112 may be different from, or identical to, each other.

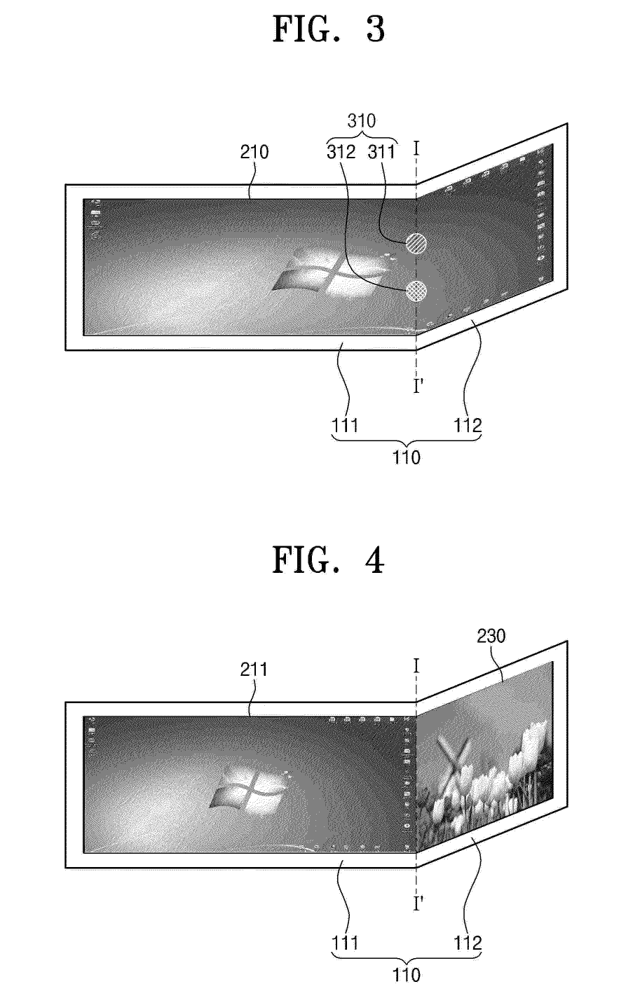

Referring to FIG. 3, the display device is forward folded. The curvature sensing unit 120 of FIG. 1 detects the forward folding of the display unit 110. The interface control unit 130 of FIG. 1 generates a forward folded interface image 310 corresponding to the forward folding of the display unit 110.

The forward folded interface image 310 is overlaid on the base image 210 and outputted. The forward folded interface image 310 may be overlaid on the position at which the forward folded occurs and outputted. The brightness of the base image 210 at the position at which the forward folded interface image 310 is overlaid may be adjusted.

The forward folded interface image 310 may include at least one of a split interface 311 for splitting the base image 210, and a maintaining interface 312 for maintaining the current base image 210. Although the split interface 311 and the maintaining interface 312 have circular shapes as shown in FIG. 3, the present invention is not limited thereto, and the shapes thereof may vary for user's convenience.

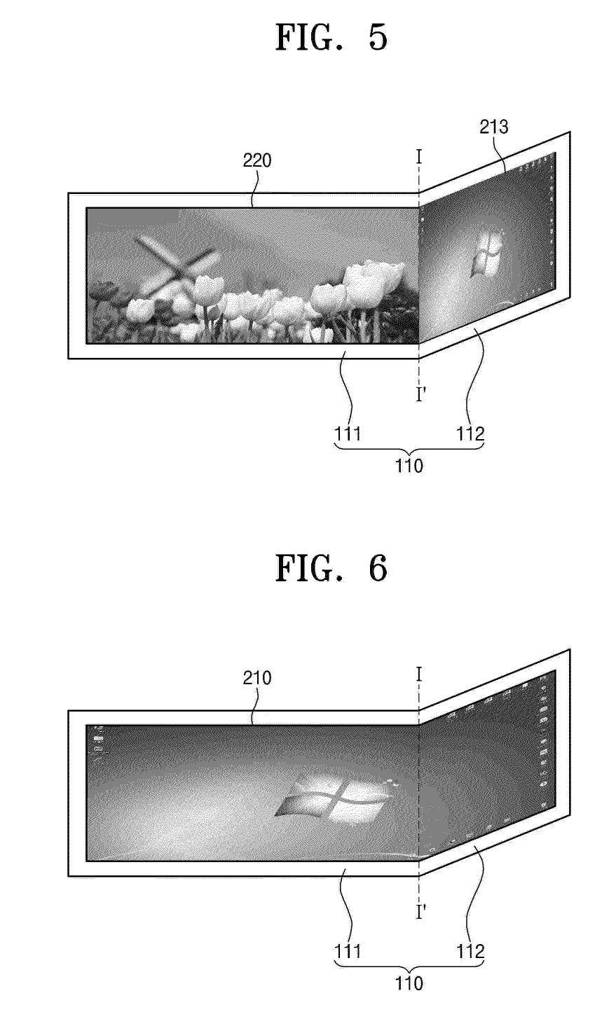

Referring to FIGS. 4 and 5, the touch sensing unit 140 of FIG. 1 may sense an input of a user selecting the split interface 311. When the touch sensing unit 140 of FIG. 1 senses an input of a user selecting the split interface 311, the first display unit 111 outputs first image data 220, and the second display unit 112 outputs second image data 230 different from the first image data 220. The first image data 220 or the second image data 220 may be a reduced base image obtained by reducing and correcting the base image 210 so as to correspond to the size of the first display unit 111 or the second display unit 112. The reduction in size of the base image among the first display unit and the second display unit may be turned off by a user, if desired.

When the split interface 311 is dragged toward the first display unit 111, as shown in FIG. 4, the reduced base image 211 corrected to the size of the first display unit 111 may be outputted to the first display unit 111, and the second image data 230 may be outputted to the second display unit 112.

When the split interface 311 is dragged toward the second display unit 112, as shown in FIG. 5, the reduced base image 213 adjusted to the size of the second display unit 112 may be outputted to the second display unit 112, and the first image data 220 may be outputted to the first display unit 111.

Referring to FIG. 6, the touch sensing unit 140 of FIG. 1 may sense an input of a user selecting the maintaining interface 312. If the touch sensing unit 140 of FIG. 1 senses an input of a user selecting the maintaining interface 312, the first display unit 111 and the second display unit 112 may output the base image 210. That is, the base image 210 may be outputted to be displayed over both the first display unit 111 and the second display unit 112 overall. At this point, stereoscopic 3D effects may be realized by folding the display unit 110.

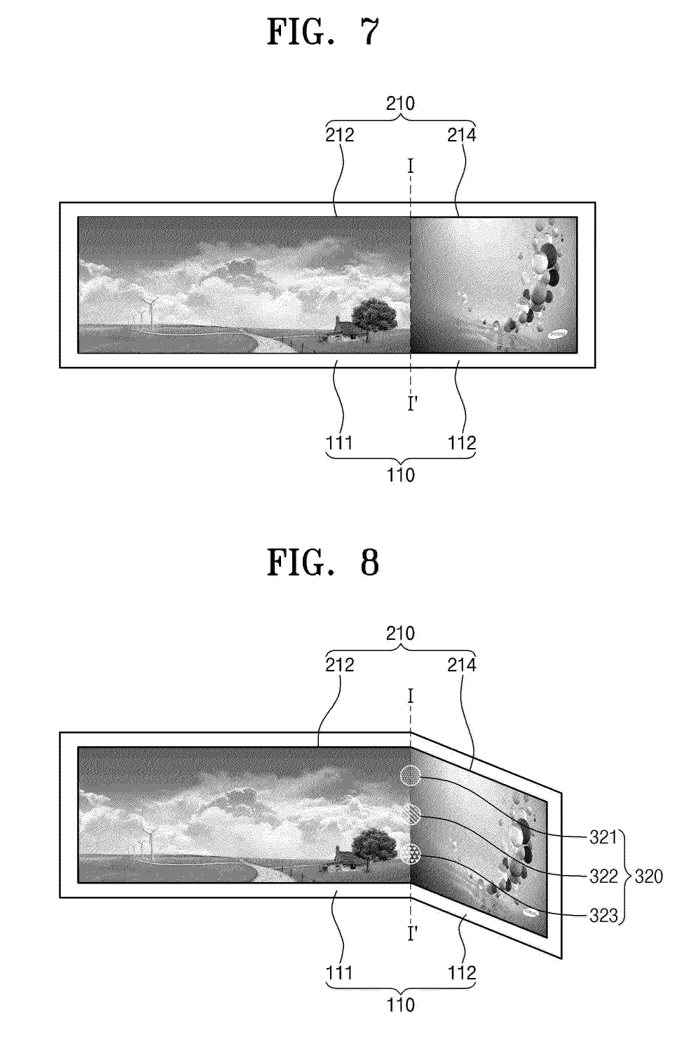

FIGS. 7 to 11 are views illustrating a display unit 110 when a display device is reverse folded according to an exemplary embodiment of the present invention.

Referring to FIG. 7, the display unit 110 outputs a base image 210. The display unit 110 may include a first display unit 111 and a second display unit 112, which are divided based on the pivotable position (for example, line I-I′ of FIG. 7) at which the forward folding and reverse folding movements occur. The sizes of the first display unit 111 and the second display unit 112 may be different from, or identical to, each other. The base image 210 includes a first base image 212 outputted to the first display unit 111, and a second base image 214 different from the first base image 212 and outputted to the second display unit 112.

Referring to FIG. 8, the display device is reverse folded. The curvature sensing unit 120 of FIG. 1 senses the reverse folding movement of the display unit 110. The interface control unit 130 of FIG. 1 generates a reverse folded interface image 320 corresponding to the reverse folding of the display unit 110.

The reverse folded interface image 320 is overlaid on the base image 210 and outputted. The reverse folded interface image 320 may overlap the position where the reverse folding movement occurs, and may be outputted. The brightness of the base image 210 at the position where the reverse folded interface image 320 is overlaid may be adjusted.

The reverse folded interface image 320 may include at least one of a switching interface 321, for switching the positions of the first base image 212 and the second base image 214; a first image interface 322 for enlarging and correcting the first base image 212 to fit on both the first display unit 111 and the second display unit 112, and outputting it; and a second image interface 323 for enlarging and correcting the second base image 214 to fit on both the first display unit 111 and the second display unit 112, and outputting it. Although the switching interface 321 has circular shapes, as shown in FIG. 8, the present invention is not limited thereto and the shapes thereof may vary for user's convenience.

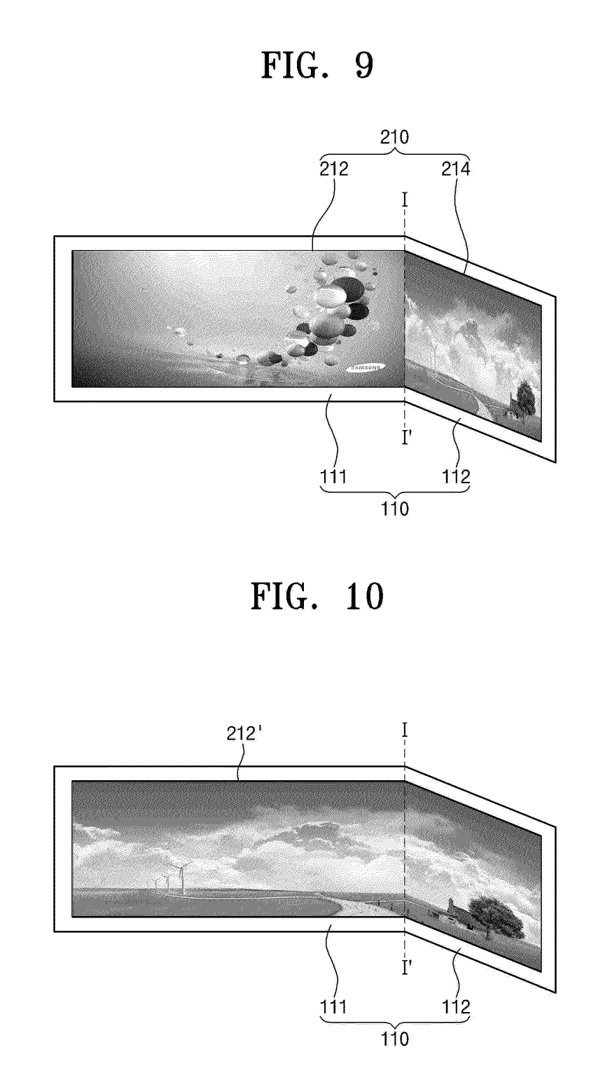

Referring to FIG. 9, the touch sensing unit 140 of FIG. 1 may sense an input of a user selecting the switching interface 321. When the touch sensing unit 140 of FIG. 1 senses an input of a user selecting the switching interface 321, the size of the second base image 214 is corrected and outputted to the first display unit 111, and the size of the first base image 212 is corrected and outputted to the second display unit. That is, the sizes of the first base image 212 and the second base image 214 are corrected, and their positions may be changed and outputted.

Referring to FIG. 10, the touch sensing unit 140 of FIG. 1 may sense an input of a user selecting the first image interface 322. When the touch sensing unit 140 of FIG. 1 senses an input of a user selecting the first image interface 322, a first enlarged base image 212′, obtained by enlarging and correcting the first base image 212, may be outputted to both the first display unit 111 and the second display unit 112. That is, the size of the first base image 212 may be enlarged and outputted to fit both the first display unit 111 and the second display unit 112 together.

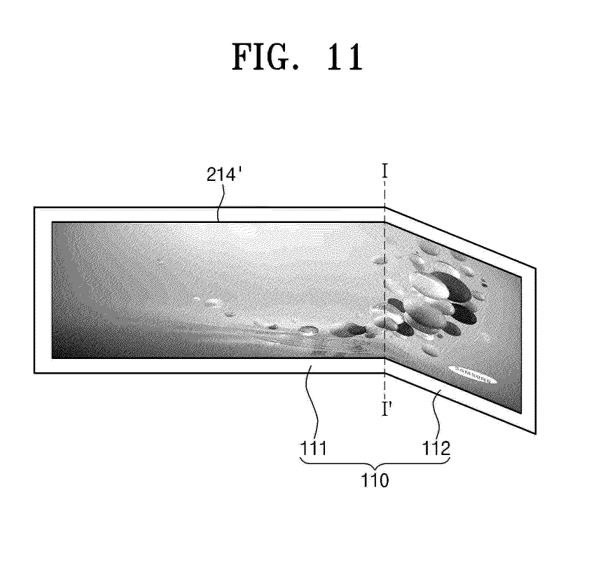

Referring to FIG. 11, the touch sensing unit 140 of FIG. 1 may sense an input of a user selecting the second image interface 323. When the touch sensing unit 140 of FIG. 1 senses an input of a user selecting the second image interface 323, a second enlarged base image 214′, obtained by enlarging and correcting the second base image 214, may be outputted to both the first display unit 111 and the second display unit 112. That is, the size of the second base image 214 may be enlarged and outputted to fit both the first display unit 111 and the second display unit 112 together.

A display device according to an exemplary embodiment of the present invention provides various interface images as the display unit is forward folded and reverse folded, so as to provide an optimized user interface according to usage environment and usage purpose.

Hereinafter, a display method of a display device according to an exemplary embodiment of the present invention is described. Only the differences between the display devices are mainly described and their overlapping descriptions are omitted.

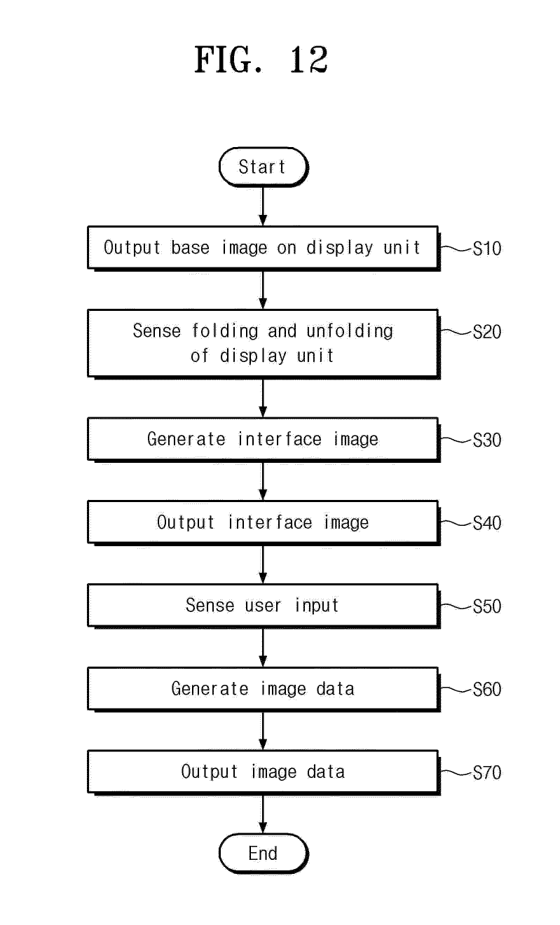

FIG. 12 is a flowchart illustrating a display method of a display device according to an exemplary embodiment of the present invention.

Referring to FIG. 12, a base image is inputted to a display unit including a first display unit and a second display unit, which are divided based on the position where forward folding and reverse folding movements occur, in operation S 10.

The display unit may include an organic light emitting display panel, a liquid crystal display panel, a plasma display panel, an electrophoretic display panel, or an electrowetting display panel.

The sizes of the first display unit and the second display unit may be different from, or identical to, each other.

The forward folded and reverse folded states of the display unit are sensed in operation S20 and an interface image is generated as the forward folded and reverse folded states of the display unit are sensed in operation S30.

The interface image may include a forward folded interface image corresponding to the forward folded state of the display unit, and a reverse folded interface image corresponding to the reverse folded state of the display unit.

The interface image is overlaid on the base image and outputted in operation S40. The interface image may be overlaid on the position where the forward folding and reverse folding movements occur and outputted, and the brightness of a base image at the position where the interface image is overlaid may be adjusted.

An input of a user selecting the interface image may be sensed in operation S50. For example, a touch sensing unit may sense an input of a user selecting the interface image, and may be configured with the display unit integrally.

The display method of a display device may further include generating image data corresponding to the sensed input of a user in operation S60, and outputting the image data to the display unit in operation S70.

In more detail, when the folded state is sensed, the outputting of the interface image may output at least one of a split interface, for splitting the base image, and a maintaining interface, for maintaining the base image.

When an input of a user selecting the split interface is sensed, the first display unit outputs first image data and the second display unit outputs second image data different from the first image data. The first image data or the second image data may be a reduced base image obtained by reducing and correcting the base image to correspond to the size of the first display unit or the second display unit. The outputting of the reduced base image among the first display unit and the second display unit may be turned off by a user, if necessary.

If an input of a user selecting the maintaining interface is sensed, the first display unit 111 and the second display unit 112 may output the base image 210. That is, the base image may be outputted to both the first display unit 111 and the second display unit 112 overall. At this point, stereoscopic 3D effects may be realized by folding the display unit.

The outputting of the base image may include outputting a base image, including a first base image outputted to the first display unit and a second base image outputted to the second display unit.

When the unfolded state is sensed, the outputting of the interface image may include outputting at least one of a switching interface for switching the positions of the first base image and the second base image; a first image interface for enlarging and correcting the first base image to fit both the first display unit and the second display unit, and outputting it; and a second image interface for enlarging and correcting the second base image to fit both the first display unit and the second display unit, and outputting it.

When an input of a user selecting the switching interface is sensed, the size of the second base image is corrected and outputted to the first display unit, and the size of the first base image is corrected and outputted to the second display unit.

When an input of a user selecting the first image interface is sensed, a first enlarged base image obtained by enlarging and correcting the first base image may be outputted to both the first display unit and the second display unit.

When an input of a user selecting the second image interface is sensed, a second enlarged base image obtained by enlarging and correcting the second base image may be outputted to both the first display unit and the second display unit.

According to exemplary embodiments of the present invention, as a display unit is folded and unfolded, various interface images are provided to a display device that includes a folded or unfolded display unit. Therefore, an optimized user interface may be provided according to usage environment and usage purpose.

According to an exemplary embodiment of the present invention, an optimized user interface may be provided to a forward folding and reverse folding display device.

According to an exemplary embodiment of the present invention, an optimized user interface may be provided to a display device through a display method of the display device.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A display device comprising:
a display unit configured to display a base image;
a curvature sensing unit configured to sense one of a forward folded state and a reverse folded state of the display unit; and
an interface control unit configured to control the display unit to overlay the base image with:
a forward folded interface image when the forward folded state is detected; and
a reverse folded interface image when the reverse folded state of the display unit is detected.

2. The device of claim 1, wherein the display unit comprises a first display unit and a second display unit that are pivotably connected at a position where forward folding and reverse folding movements occur.

3. The device of claim 2, further comprising a touch sensing unit configured to detect a selection one of the forward folded interface image and the reverse folded interface image.

4. The device of claim 3, further comprising an image control unit configured to generate image data corresponding to one of the forward folded interface image and the reverse folded interface image, and to output the image data to the display unit.

5. The device of claim 4, wherein the forward folded interface image comprises a split interface configured to split the base image, and a maintaining interface configured to maintain the base image.

6. The device of claim 5, wherein the split interface comprises:
first image data displayed by the first display unit;
second image data displayed by the second display unit, the second image data being different from the first image data; and
the first image data comprises a version of the base image resized for display on the first display unit.

7. The device of claim 6, wherein:
when the split interface is dragged toward the first display unit, the resized base image is displayed by the first display unit; and
when the split interface is dragged toward the second display unit, the resized base image is displayed by the second display unit.

8. The device of claim 6, wherein when the touch sensing unit senses an input of a user selecting the maintaining interface, the first display unit and the second display unit display the base image.

9. The device of claim 4, wherein the base image comprises a first base image output to the first display unit and a second base image output to the second display unit.

10. The device of claim 9, wherein the reverse folded interface image comprises at least one of:
a switching interface configured to switch positions of the first base image and the second base image;
a first image interface configured to resize the first base image to fit both the first display unit and the second display unit; and
a second image interface configured to resize the second base image to the size of both the first display unit and the second display unit.

11. The device of claim 10, wherein, when the touch sensing unit senses an input of a user selecting the switching interface, the second base image is resized and output to the first display unit, and the first base image is resized and output to the second display unit.

12. The device of claim 10, wherein when the touch sensing unit detects an input of a user selecting the first image interface, an enlarged first base image is output to both the first display unit and the second display unit together.

13. The device of claim 10, wherein when the touch sensing unit detects an input of a user selecting the second image interface, an enlarged second base image is output to both the first display unit and the second display unit together.

14. A display method for a display device, the method comprising:
outputting a base image on a display unit, the display unit comprising a first display unit and a second display unit that are pivotably connected at a position where forward folding and reverse folding movements occur;
sensing one of a forward folded state and a reverse folded state of the display unit;
generating an interface image when one of the forward folded state and reverse folded state of the display unit is sensed; and
overlaying the interface image on the base image, and outputting the overlaid image.

15. The method of claim 14, further comprising:
sensing an input of a user selecting the interface image;
generating image data corresponding to the sensed input of the user; and
outputting the image data on the display unit.

16. The method of claim 15, wherein, when the forward folded state is sensed, the outputting of the interface image comprises outputting at least one of a split interface configured to split the base image, and a maintaining interface configured to maintain the base image.

17. The method of claim 15, wherein the outputting of the base image comprises outputting a base image comprising a first base image output to the first display unit and a second base image output to the second display unit.

18. The method of claim 17, wherein, when one of the forwarded folded state or the reverse folded state is sensed, the outputting of the interface comprises outputting at least one of:
a switching interface configured to switch positions of the first base image and the second base image;
a first image interface configured to enlarge the first base image to fit the first display unit or the second display unit, and to output the enlarged image; and
a second image interface configured to enlarge the second base image to fit the size of the first display unit or the second display unit, and to output the enlarged image.
